(19) United States
(12) Patent Application Publication
(10) Pub. No.: US 2012/0138174 A1
(43) Pub. Date: Jun. 7, 2012

(54) APPARATUS FOR REGULATING FLOW RATE OF COOLING AIR FOR VEHICLE AND COOLING APPARATUS FOR HYBRID VEHICLE USING THE SAME

(75) Inventor: Seung Jin Baek, Hwaseong (KR)

(73) Assignee: HYUNDAI MOTOR COMPANY, Seoul (KR)

(21) Appl. No.: 13/183,609

(22) Filed: Jul. 15, 2011

(30) Foreign Application Priority Data
Dec. 3, 2010 (KR) 10-2010-0122444

(51) Int. Cl. F15D 1/00

(52) U.S. Cl. 137/561 R

(57) ABSTRACT

The present invention relates to an apparatus for regulating a flow rate of cooling air for a vehicle, and a cooling apparatus for a hybrid vehicle using the same. The apparatus for regulating a flow rate of cooling air for a vehicle comprises: a front plate and a rear plate each having a plurality of cooling holes, the cooling holes of the front plate corresponding to the cooling holes of the rear plate; and solenoids provided on opposite sides of the front plate or rear plate and configured to drive slide movement of the front plate or rear plate. A first introduction region and a second introduction region are formed in the stacked front plate and rear plate such that the cooling holes of the first introduction region have a size different from that of the cooling hole of the second introduction region.

### CROSS-REFERENCE TO RELATED APPLICATION

This application claims under 35 U.S.C. §119(a) the benefit of Korean Patent Application No. 10-2010-0122444 filed Dec. 3, 2010, the entire contents of which are incorporated herein by reference.

### BACKGROUND

(a) Technical Field

The present invention relates to an apparatus for regulating a flow rate of cooling air for a vehicle and a cooling apparatus for a hybrid vehicle using the same. More particularly, it relates to an apparatus for regulating a flow rate of cooling air for vehicle by using slide movements of plates having cooling holes of different sizes, thereby reducing an air resistance of a vehicle and optimizing a cooling effect, and a cooling apparatus for a hybrid vehicle using the same.

(b) Background Art

A typical hybrid vehicle generally radiates a very large amount of heat as compared with other combustion engine vehicles. It therefore requires a very high level of requirements such as a cooling temperature.

To this end, a conventional cooling apparatus for a hybrid vehicle includes a condenser, an electric part radiator, an engine radiator, and a cooling fan. In particular, an electric part radiator in charge of cooling electric parts (e.g., a travelling motor) is generally arranged in front of an engine radiator together with a condenser.

Referring to FIG. 5 which illustrates an arrangement of elements of a cooling apparatus 10, an electric part radiator 12 is arranged on the foremost side of the front of a vehicle, and a condenser 14 and an engine radiator 16 are arranged in that order on the rear side of the electric part radiator 12 while maintaining certain distances from the electric part radiator 12. It is also possible to dispose the electric part radiator 12 and the condenser 14 on the front of the vehicle from left to right or from top to bottom and to dispose the engine radiator 16 on the rear side thereof.

The electric part radiator 12 and the condenser 14 perform cooling operations independently. Generally, the condenser 14 serves to cool the interior of the vehicle while forming a refrigerant cycle together with a compressor. An evaporator and the electric part radiator 12 serve to cool down cooling water after heat-exchange with a junction box, various batteries, and a controller as well as a travelling motor. It is apparent that the engine radiator 16 serves to cool engine cooling water independently.

A radiator grill (not shown) configured to guide exterior cooling air toward the radiators 12 and 16 and the condenser 14 is formed at an upper portion of the front of the radiators 12 and 16 and the condenser 14. Exterior cooling gas, which has passed the radiator grill, is introduced into the radiators 12 and 16 and the condenser 14 to prevent them from becoming overheated. Meanwhile, if the radiator grill remains open, the engine cooling water cannot be rapidly warmed up at the initial stage of start-up with a relatively low exterior temperature, thus lowering operation efficiency of the engine. Fuel efficiency is also lowered because the open radiator grill increases resistance by air while the vehicle travels.

In an attempt to address the above-mentioned problems, there has been developed an active air flap device, which is configured to open and close a plurality of flaps formed at locations where exterior air is introduced to the engine room, and which can prevent introduction of exterior air in some situations.

However, since the flaps are collectively opened in a situation where only one of the electric part radiator, the engine, or the condenser need to be cooled, they are closed substantially for a short period of time. Accordingly, the active air flap device can neither reduce resistance by air while the vehicle travels, nor can it maximize an effect of improving fuel efficiency. Furthermore, since a motor should be situated at a central portion of the active air flap device to smoothly control the flaps, there are limitations in design and an increase in costs due to the presence of a motor.

Meanwhile, Korean Patent No. 10-0508176 suggests a wind flow regulating apparatus for a radiator grill which has a radiator structure having a front mesh plate and a rear mesh plate in which the rear mesh plate can be moved by a certain section by a modulator according to a temperature of cooling water of an engine. However, the wind flow regulating apparatus has a drawback when it is applied to a hybrid vehicle having a plurality of heat exchangers. In particular, it requires cooling of all the heat exchangers (radiators and condenser) even when there is a need for cooling only a single heat exchanger.

### SUMMARY OF THE DISCLOSURE

The present invention provides an apparatus for regulating a flow rate of cooling air for a vehicle and a cooling apparatus for a hybrid vehicle using the same. In particular, the present invention provides an apparatus that regulates a flow rate of cooling air according to cooling requirement situations of individual heat exchangers, thereby reducing air resistance and optimizing a cooling effect while the vehicle is travelling.

In one aspect, the present invention provides an apparatus for regulating a flow rate of cooling air for a vehicle, the apparatus comprising: a front plate and a rear plate each having a plurality of cooling holes, the cooling holes of the front plate corresponding to the cooling holes of the rear plate; and solenoids provided on both end sides of the front plate and configured to drive slide movement of the front plate, wherein a first introduction region and a second introduction region are formed in the stacked front plate and rear plate such that the cooling holes of the first introduction region have a size different from that of the cooling hole of the second introduction region.

In certain preferred embodiments, solenoids may be provided on both end sides of the rear plate and may be configured to drive slide movement of the rear plate.

Preferably, a width of the cooling holes formed in the second introduction region of the front plate and the rear plate, with respect to a slide movement direction of the front plate, are larger than the cooling holes formed in the first introduction region of the front plate and the rear plate. In various embodiments, width of these cooling holes formed in the second introduction region of the front plate and the rear plate may be twice as large as that of the cooling holes formed in the first introduction region of the front plate and the rear plate.

Preferably, the solenoids may perform a drive operation such that a state of the apparatus is one of: (i) a first state where both the first introduction region and the second introduction region are blocked, (ii) a second state where the first introduction region is fully opened and the second introduction is partially opened, and (iii) a third state where the first introduction region is blocked and the second introduction region is fully opened.

In another aspect, the present invention provides a cooling apparatus for a hybrid vehicle comprising: an apparatus for regulating a flow rate of cooling air for a vehicle in accordance with the present invention; a condenser arranged to face the first introduction region of the apparatus for regulating a flow rate of cooling air for a vehicle; an electric part cooling radiator arranged to face the second introduction region of the apparatus for regulating a flow rate of cooling air for a vehicle; and an engine cooling radiator arranged on a rear side of the condenser and the electric part cooling radiator.

According to an apparatus for regulating a flow rate of cooling air for a vehicle and a cooling apparatus for a hybrid vehicle using the same, a flow rate of cooling air can be regulated according to cooling requirement situations of individual heat exchangers, thereby reducing air resistance and optimizing a cooling effect when the vehicle travels.

Further, according to the present invention, space availability can be increased by providing the plates in a sliding configuration instead of a conventional flap rotating manner, making it possible to avoid restrictions in design.

Moreover, the apparatus for regulating a flow rate of cooling air for a vehicle of the present invention uses solenoids to drive plates instead of a motor, thereby reducing manufacturing cost.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a schematic diagram illustrating an apparatus for regulating a flow rate of cooling air for a vehicle and a cooling apparatus for a hybrid vehicle using the same according to an embodiment of the present invention;

FIG. 2 is a diagram illustrating an opening/closing operation of the apparatus for regulating a flow rate of cooling air for a vehicle according to an embodiment of the present invention;

FIG. 3 is a flow chart illustrating a method of controlling the cooling apparatus for a hybrid vehicle according to an embodiment of the present invention;

FIG. 4 is a view illustrating control conditions of the cooling apparatus for a hybrid vehicle according to an embodiment of the present invention; and

FIG. 5 is a schematic diagram illustrating a conventional cooling apparatus for a hybrid vehicle.

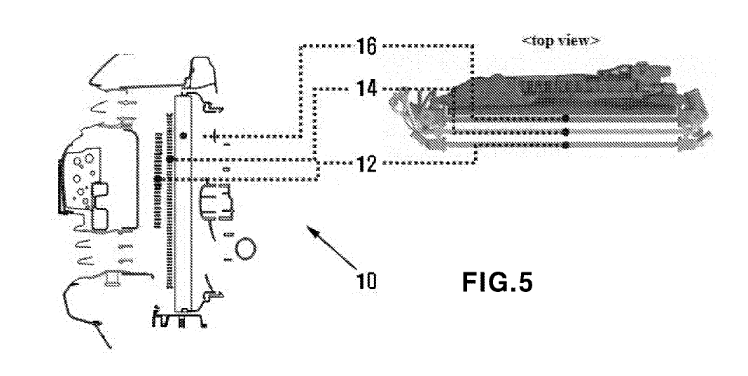

### DETAILED DESCRIPTION

Hereinafter, an exemplary embodiment of the present invention will be described below in detail with reference to the accompanying drawings such that those skilled in the art to which the present invention pertains can easily practice the present invention.

In the detailed description of the invention, a cooling apparatus for a hybrid vehicle including an electric part cooling radiator, a condenser, and an engine cooling radiator will be exemplified. However, an apparatus for regulating a flow rate of cooling air for a vehicle and a cooling apparatus for a vehicle using the same according to the present invention may be applied to various other types of vehicles having multiple (particularly three or more) heat exchangers.

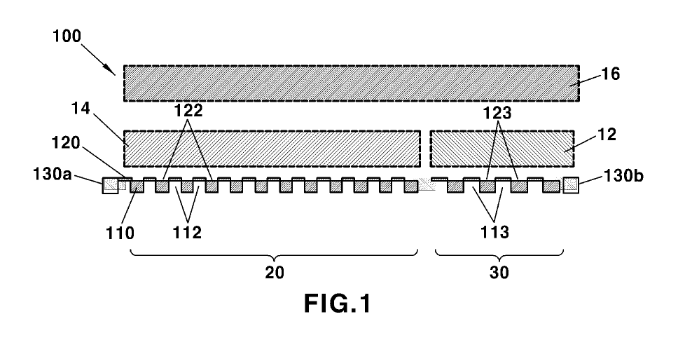

FIG. 1 illustrates an apparatus for regulating a flow rate of cooling air for a vehicle and a cooling apparatus 100 for a hybrid vehicle using the same according to an embodiment of the present invention. As shown, the cooling apparatus 100 for a hybrid vehicle may include a condenser 14 and an electric part radiator 12 arranged on the left and right sides of the front of a vehicle, and an engine cooling radiator 16 arranged on the rear side thereof.

In various embodiments, the apparatus for regulating a flow rate of cooling air for a vehicle may be provided in front of the radiators 12 and 16 and the condenser 14. The apparatus for regulating a flow rate of cooling air includes a front plate 110 and a rear plate 120, wherein a plurality of cooling holes 112, 113, 122, and 123 are formed in the plates 110 and 120, respectively.

As shown, the cooling holes 112 and 122 in the front plate 110 and the rear plate 120 are arranged on the side of the condenser 14 to form a first introduction region 20. The cooling holes 113 and 123 are arranged on the side of the electric part cooling radiator 12 to form a second introduction region 30. The cooling holes 112 and 113 formed in the front plate 110 and the cooling holes 122 and 123 formed in the rear plate 120 are disposed at corresponding locations such that they coincide with each other (i.e. are in alignment) or deviate from each other (i.e. are out of alignment) as the front plate 110 and/or the rear plate 120 slides to thereby open and close the first introduction region 20 and the second introduction region 30.

In an embodiment of the present invention, the cooling holes 112 and 122 formed in the first introduction region 20 and the cooling holes 113 and 123 formed in the second introduction region 30 may differ in their size. Preferably, the size of the cooling holes 113 and 123 formed in the second introduction region 30 may be larger than those of the cooling holes 112 and 122 formed in the first introduction region 20 (as depicted in FIG. 1). In certain preferred embodiments, the width of the cooling holes 113 and 123 formed in the second introduction region 30 in the direction of slide movement may be twice as large as those of the cooling holes 112 and 122 formed in the first introduction region 20. Of course, other relationships between the sizes of the cooling holes could also be provided as desired.

As shown in the embodiment of FIG. 1, solenoids 130a and 130b for slide movement of the front plate 110 are provided on both end sides of the front plate 110. The solenoids 130a and 130b move the front plate 110 to the left and right to regulate an opening/closing operation of the first introduction region 20 and the second introduction region 30.

Meanwhile, according to another embodiment of the present invention, the solenoids 130a and 130b are provided on both end sides of the rear plate 120 to thereby move the rear plate 120 and regulate the opening/closing operation of the first introduction region 20 and the second introduction region 30. In various embodiments, the apparatus for regulating a flow rate of cooling air may open or close the first introduction region 20 and the second introduction region 30 by moving the plates up and down. That is, the solenoids 130a and 130b may be provided on upper and lower sides of the front plate 110 or the rear plate 120 so as to move the front plate 110 and the rear plate 120 up and down. It is further noted that while solenoids 120a and 130b are described as being provided in the front plate 110 or rear plate 120, the solenoids could also be provided in both the front and rear plates 110, 120 if desired.

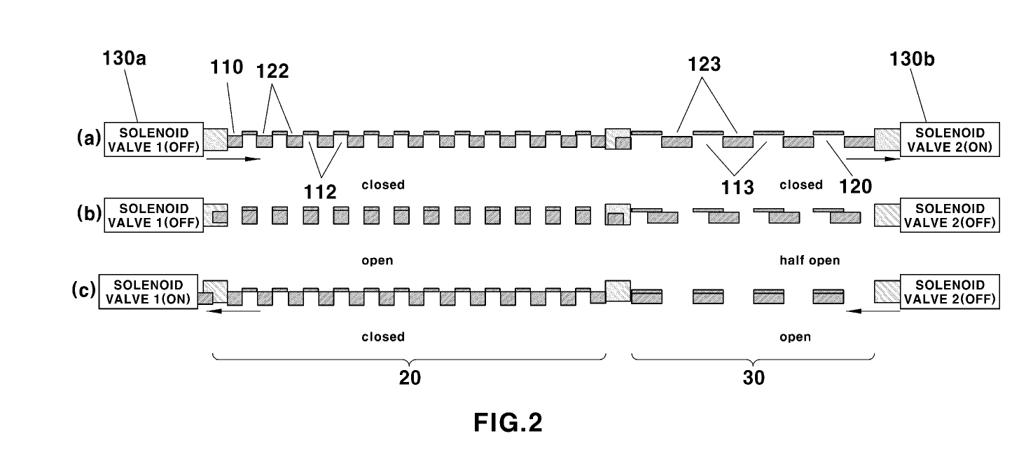

FIG. 2 illustrates an embodiment of the present invention for the opening/closing operation of the apparatus for regulating a flow rate of cooling air for a vehicle according to the operations of the solenoids 130a and 130b. FIG. 2A illustrates a state where the first introduction region 20 and the second introduction region 30 are all closed. FIG. 2B illustrates a state where the first introduction region 20 is opened and the second introduction region 30 is partially opened. FIG. 2C illustrates a state where the first introduction region 20 is closed and the second introduction region 30 is fully opened.

According to an embodiment of the present invention, the front plate 110 and the rear plate 120 form the first introduction region 20 and the second introduction region 30, and the condenser 14 of the cooling apparatus may be arranged to face the first introduction region 20 while the electric part cooling radiator 12 may be arranged to face the second introduction region 30.

According to an embodiment of the present invention, the first introduction region 20 facing the condenser may have an area larger than that of the second introduction region 30 facing the electric part cooling radiator. This can be beneficial because the amount of required heat rejection of the condenser 14 is generally larger than that of heat rejection of the electric part cooling radiator 12.

Then, the opening/closing operations of the first introduction region 20 and the second introduction region 30 may be performed by the solenoid 130a and 130b provided on both end sides of the front plate 110. That is, as the front plate 110 slides, the cooling holes 112 and 113 formed in the front plate 110 are moved together, and as the relative positions of the cooling holes 112 and 113 of the front plate 110 with respect to the cooling holes 122 and 123 formed in the rear plate 120 are changed, the opening degrees of the first introduction region 20 and the second introduction region 30 may be regulated together. As noted above, in certain embodiments the solenoid 130a and 10b can be provided on opposite sides of the rear plate 120, and would thus similarly move so as to vary the relative positions of the cooling holes 112, 113, 122, 123.

First, if the second solenoid 130b provided on the left side of the front plate 110 is driven in a reference state (second state) shown in FIG. 2B, the front plate 110 is slid to the right by one section relative to the width of the cooling holes 112 and 122 formed in the first introduction region 20 into a first state shown in FIG. 2A.

In the first state, the cooling holes 112 and 122, 113 and 123 formed in the front plate 110 and the rear plate 120 correspondingly are alternately disposed such that both the first introduction region 20 and the second introduction region 30 can be closed. Accordingly, all the introduction regions of the apparatus for regulating a flow rate of cooling air for a vehicle according to the present invention are closed, preventing exterior cooling air from being introduced.

Next, the reference state (second state) shown in FIG. 2B is a state formed by moving the front plate 110 by one section relative to the width of the cooling holes 112 and 122 formed in the first introduction region 20 with respect to the first state. That is, according to an embodiment of the present invention, when the width of the cooling holes 113 and 123 formed in the second introduction region 30 is formed to be larger than the width of the cooling holes 112 and 122 formed in the first introduction region 20, when the cooling holes 112 and 122 formed in the first introduction region 20 coincide with each other, the cooling holes 113 and 123 formed in the second introduction region 30 may be partially deviated (i.e. partially out of alignment).

Accordingly, exterior cooling air can be introduced maximally in the first introduction region 20 of the apparatus for regulating a flow rate of cooling air for a vehicle according to the present invention, and exterior cooling air can be partially introduced in the second introduction region 30.

Preferably, in some embodiments the width of the cooling holes 113 and 123 formed in the second introduction region 30 may be twice as large as those of the cooling holes 112 and 122 formed in the first introduction region 20. Accordingly, when the first introduction region 20 is fully opened, a half of the second introduction region 30 may be opened.

Meanwhile, if the first solenoid 130a provided on the left side of the front plate 110 is driven in the reference state (second state) shown in FIG. 2B, the front plate 110 is slid by one section relative to the width of the cooling holes 112 and 122 formed in the first introduction region 20 into a third state shown in FIG. 2C.

In the third state, the cooling holes 112 and 122 formed in the first introduction region 20 are deviated (i.e. out of alignment) and the cooling holes 113 and 123 formed in the second introduction region 30 coincide with each other (i.e. are in alignment), closing the first introduction region 20 and fully opening the second introduction region 30. That is, in the third state, the first introduction region 20 of the apparatus for regulating a flow rate of cooling water for a vehicle according to the present invention blocks exterior cooling air from being introduced into the first introduction region 20, and allows exterior cooling air to be introduced maximally the second introduction region 30.

The apparatus for regulating a flow rate of cooling air for a vehicle according to the present invention variably regulates a first state where both the first introduction region and the second introduction region are blocked, a second state where the first introduction region is fully opened and the second introduction region is partially opened, and a third state where the first introduction region is blocked and the second introduction region is fully opened.

Referring to FIGS. 1 and 2, in the first state, the condenser 14, the electric part cooling radiator 12, and the engine cooling radiator 16 are not cooled, and the resistance of air due to travelling of the vehicle is reduced to the greatest extent.

In the second state, the condenser 14 arranged in the first introduction region 20 is cooled (wherein the cooling air is fully allowed to enter the first introduction region through the completely open cooling holes 112, 122), and the electric part cooling radiator 12 arranged in the second introduction unit 30 cooled to some extent (wherein the cooling air is allowed to enter the second introduction region through the partially open cooling holes 113, 123). Then, as exterior cooling air is maximally introduced (in other words, is allowed to enter the fully open cooling holes 112, 122) through the first introduction region 20 having an area larger than that of the second introduction region 30, the engine cooling radiator 16 arranged on the rear side of the condenser 14 and the electric part cooling radiator 12 is also cooled maximally (in other words, at this state the greatest amount of cooling air is introduced to the engine cooling radiator 12 to cool it) by the air entering the fully open cooling holes 112, 122 and the partially open cooling holes 113, 123.

Meanwhile, in the third state, the condenser 14 arranged in the first introduction region 20 is not cooled because the cooling holes 112,122 are closed, and the electric part cooling radiator 12 arranged in the second introduction region 30 is cooled maximally because the cooling holes 113, 123 are completely open. At this time, the engine cooling radiator 16 arranged on the rear side of the electric part cooling radiator 12 is also partially cooled.

Thus, the apparatus for regulating a flow rate of cooling air for a vehicle according to the present invention can regulate a flow rate of cooling air according to cooling requirement situations of the individual heat exchangers, thereby reducing air resistance and optimizing a cooling effect at the same time.

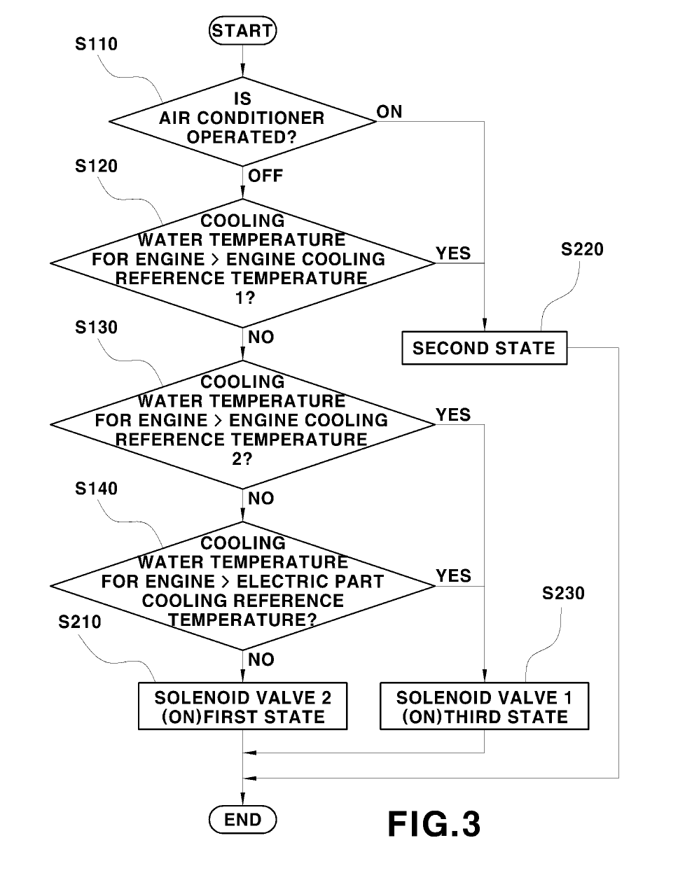

FIG. 3 is illustrates a method of controlling a cooling apparatus for a hybrid vehicle to which the apparatus for regulating a flow rate of cooling air for a vehicle according to an embodiment of the present invention.

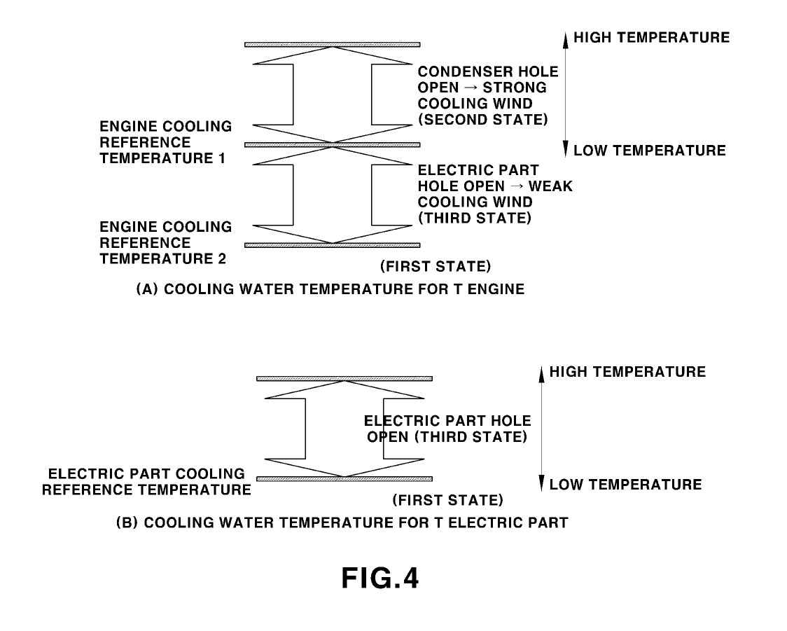

FIG. 4 illustrates control conditions of the cooling apparatus for a hybrid vehicle.

First, referring to FIG. 4, the cooling apparatus for a hybrid vehicle according to the present invention can regulate a flow rate of cooling air according to a temperature of cooling water for an engine (FIG. 4A) and regulate a flow rate of cooling air according to a temperature of cooling water for an electric part.

That is, referring to FIG. 3, if an air conditioner of a hybrid vehicle is operated (S110) or a temperature of cooling water for an engine exceeds a first reference temperature (S120), a second state where the first introduction region on the side of the condenser is fully opened is entered. In the second state, as discussed previously, the condenser is cooled and the engine cooling radiator is cooled maximally.

Meanwhile, if a temperature of cooling water for the engine is between a second engine cooling reference temperature and a first engine cooling reference temperature (S130) or a temperature of cooling water for electric parts exceeds an electric part cooling reference temperature (S140), a third state where the second introduction region on the side of the electric part cooling radiator may be entered. In the third state, as discussed previously, the electric part cooling radiator is cooled maximally and the engine cooling radiator is partially cooled at the same time.

If both conditions of S110 to S140 are not satisfied, the first state where both the first introduction region and the second introduction region are blocked will be entered. In this state, the radiator and the condenser are not cooled down by cooling air.

According to the apparatus for regulating a flow rate of cooling air for a vehicle according to the present invention, the condenser, the electric part cooling radiator, and the engine cooling radiator of the hybrid vehicle can be cooled at an optimum efficiency depending on cooling requirements.

Moreover, the apparatus for regulating a flow rate of cooling air for a vehicle may be applied to various types of vehicles having multiple, preferably three or more, heat exchangers as well as to a hybrid vehicle as in Table 1, and a cooling apparatus for a vehicle using the same may be constructed.

TABLE 1

| | Hybrid | Gasoline | Fuel Cell | General |
|---|---|---|---|---|
| | Vehicle | Vehicle | Vehicle | Properties |
| Heat | Engine | Engine | Stack | High Heat |
| Exchanger 1 | Cooling | Cooling | Cooling | Rejection |
| | Radiator | Radiator | Radiator | Temperature |
| Heat | Condenser | Condenser | Condenser | Intermediate |
| Exchanger 2 | | | | Heat Rejection |
| | | | | Temperature |
| Heat | Electric Part | None or Oil | None or Oil | Low Heat |
| Exchanger 3 | Cooling | Cooling | Cooling | Rejection |
| | Radiator | | | Temperature |

That is, according to the apparatus for regulating a flow rate of cooling air for a vehicle according to the present invention, the first introduction region faces a second heat exchanger, the second introduction region faces a third heat exchanger, and a first heat exchanger is arranged on the rear side of the second heat exchanger and the third heat exchanger, realizing a cooling apparatus for various types of vehicles.

The invention has been described in detail with reference to an exemplary embodiment thereof. However, it will be appreciated by those skilled in the art that changes may be made in these embodiments without departing from the principles and spirit of the invention, the scope of which is defined in the appended claims and their equivalents. Further, many modifications may be made to specific situations and materials without departing from the essence of the invention. Therefore, the present invention is not limited to the detailed description of the preferred embodiment but includes all embodiments within the scope of the attached claims.

What is claimed is:

1. An apparatus for regulating a flow rate of cooling air for a vehicle, the apparatus comprising:
a front plate and a rear plate each having a plurality of cooling holes, the cooling holes of the front plate corresponding to the cooling holes of the rear plate; and
solenoids provided on opposite sides of the front plate or rear plate and configured to drive slide movement of the front plate or rear plate,
wherein a first introduction region and a second introduction region are formed when the front plate and rear plate are stacked such that the cooling holes of the first introduction region have a size different from that of the cooling hole of the second introduction region.

2. The apparatus as claimed in claim 1, wherein the solenoids are provided on opposite sides of the rear plate and are configured to drive slide movement of the rear plate.

3. The apparatus as claimed in claim 1, wherein a width of the cooling holes formed in the second introduction region of the front plate and the rear plate is twice as large as the width of the cooling holes formed in the first introduction region of the front plate and the rear plate.

4. The apparatus as claimed in claim 3, wherein the solenoids perform a drive operation such that a the apparatus is provided in three states, wherein in a first state both the first introduction region and the second introduction region are blocked, in a second state the first introduction region is fully opened and the second introduction is partially opened, and in a third state the first introduction region is blocked and the second introduction region is fully opened.

5. A cooling apparatus for a hybrid vehicle comprising:
an apparatus for regulating a flow rate of cooling air for a vehicle as claimed in claim 1;
a condenser arranged to face the first introduction region of the apparatus for regulating a flow rate of cooling air for a vehicle;
an electric part cooling radiator arranged to face the second introduction region of the apparatus for regulating a flow rate of cooling air for a vehicle; and
an engine cooling radiator arranged on a rear side of the condenser and the electric part cooling radiator.
